(19) United States
(12) Patent Application Publication
(10) Pub. No.: US 2006/0029797 A1
(43) Pub. Date: Feb. 9, 2006

(54) Linerless, self-fusing elastomeric tape

(76) Inventors: Paul R. Rust, Evansville, IN (US); Timothy R. Robards, Evansville, IN (US)

Correspondence Address: Gary K. Price, Esq.;Bowers Harrison, LLP, 25 N.W. Riverside Drive, Evansville, IN, 47706-1287, US

(21) Appl. No.: 11/200,894

(22) Filed: Aug. 9, 2005

Related U.S. Application Data
(60) Provisional application No. 60/573,065, filed on Aug. 9, 2004.

(51) Int. Cl. D04H 1/00; D03D 15/00; B32B 27/04; B32B 7/12

(52) U.S. Cl. 428/343; 442/149; 442/2; 442/6

(57) ABSTRACT

A linerless, self-fusing elastomeric tape having an adhesive layer and a mesh that serves as a release liner in storage and further is a part of said tape in a sealing function. The adhesive layer includes blends of a first halogenated rubber component and a second non-halogenated modified rubber component. In application, the stretched mesh includes a plurality of openings such that when the adhesive layer and mesh is stretched, the mesh allows cross-linking between the layers of the adhesive layer through the plurality of openings allowing the layers to extrude through the openings of the mesh for purposes of bonding.

### CROSS REFERENCES TO RELATED APPLICATIONS

U.S. Provisional Application for Patent No. 60/573,065, filed Aug. 9, 2004, with title “Linerless, Self-Fusing Elastomeric Tape” which is hereby incorporated by reference. Applicant claims priority pursuant to 35 U.S.C. Par. 119(e)(i).

Statement as to rights to inventions made under federally sponsored research and development: Not Applicable

### BACKGROUND OF THE INVENTION

1. Field of the Invention

The invention relates generally to the field of tapes used in a sealing function when protecting or sealing pipes, pipe joints, pipe connectors, electrical wires, cables, connectors, and the like, and more particularly to a linerless, self-shrinking, cross-linking, self-fusing elastomeric tape that includes a mesh layer that serves as a liner in storage, and yet is a part of the tape in application.

2. Brief Description of Prior Art

Many articles are coated for protection from the environment in a variety of ways including the application of a thin sheet or tape in a wrapping operation. The technology for the application of such coatings generally includes a highly tacky separate adhesive layer used to achieve adhesion to the substrate and overlapping layers to each other. These tapes are usually tacky in the relaxed state rendering them difficult to handle and, when formed into a roll or liner adhere together rendering them difficult if not impossible to unwind after a short time. To avoid this problem, self-adhering tapes of the prior art have been provided with a removable liner between overlapping layers. Removal of the liner is time consuming and may be difficult when it becomes tightly adhere to the tape.

As will be seen from the subsequent description, the preferred embodiments of the present invention overcome shortcomings of the prior art.

### SUMMARY OF THE INVENTION

The present invention in the preferred embodiment is a rubber composition intended for, but not restricted to, use as a sealing tape that includes a first component that is a halogenated rubber, or combination thereof, and a second component that is a non-halogenated rubber. By inciting cross-linking between layers of the rubber composition, the one layer is substantially non-tacky in the relaxed state while the adjacent layer is tacky. Both layers are composed of a semi-cross-linked elastomer that when forced into intimate contact, will further fuse with increase of time and temperature providing improved stability and strength. This results in a continued presence of an inward pressure on the wrapped area for the life of the splice.

The tape of the present invention further includes a mesh that when in its relaxed state, acts as a release liner between the layers of the rubber composition. When the tape is wrapped in an application, the mesh is likewise stretched and wrapped allowing cross-linking between the layers of the composition through a plurality of openings in the stretched mesh. Particularly, allowing the layers to extrude through the openings of the mesh for purposes of bonding.

### BRIEF DESCRIPTION OF THE DRAWINGS

FIG. 1 is a perspective view of the preferred embodiment of the present invention, a linerless, self-fusing elastomeric tape.

FIG. 2 is an exploded view of the linerless, self-fusing elastomeric tape illustrated in FIG. 1.

FIG. 3 is a partial sectional view of the linerless, self-fusing elastomeric tape illustrated in FIG. 1.

FIG. 3A is an enlarged view of the mesh portion illustrated in FIG. 3.

FIG. 4 illustrates the preferred embodiment of the present invention being applied around the circumference of a substrate.

### DESCRIPTION OF THE PREFERRED EMBODIMENT

In accordance with the present invention, a linerless, self-fusing, cross-linking elastomeric tape is disclosed. The present invention discloses a rubber composition that is substantially non- tacky in the relaxed state but whose overlapping layers cross-link layer to layer when stretched and wrapped on a substrate. In the broadest context, the composition blend of the present invention consists of components configured and correlated with respect to each other so as to attain the desired objective.

Referring to FIGS. 1-4, a preferred embodiment of the present invention, a linerless, self-fusing elastomeric tape 10 is disclosed. The tape 10 generally includes a rubber composition blend 12 and a mesh 14. The blend 12 comprises at least two components: a halogenated rubber component and a non-halogenated modified component.

Any cross-linkable polymer may be employed in the practice of this invention. The halogenated rubber component may include, but is not in any way limited to, the following polymers: butyl rubber, halogenated butyl rubber, isobutylene, homopolymer, ethylene/propylene/diene terpolymers, ethylene/propylene copolymers, polybutadiene, polyisoprene, halogenated isoolefin/paralkylstyrene copolymer, natural rubber and combination mixtures thereof.

The blend composition 12 further includes a cure system to allow the resultant product to have cross-linkable properties at room temperature. The cure system as will be described is preferably blended with the halogenated rubber component.

The cure system is a combination of phenolic resins. The amount of the curing agent will generally vary depending upon the types utilized and especially the desired degree of cure, as is well recognized in the art. However, in general, the preferred embodiment of the cure system is about 0.5% to about 1.5% of the total mixture blend.

It has now been found that the incorporation in the halogenated rubber component of the described cure system, in the amounts described, produces a marked improvement in the resultant product's cross-linking properties and further causes the blend to be room temperature cross-linkable.

Various additives can be further used in suitable amounts. For example, various reinforcing agents or fillers known in the art may be combined with the blend 12 at any point during production. Further, various colorants may be added such as carbon black and the like, and various resins known in the art can be utilized in the present blend. Moreover, the inclusion of a separate tackifier known in the art and known for its intended purposes preferred.

The described mixture 12 further incorporates a petroleum product, preferably polybutene. The preferred proportion of polybutene in the mixture is from about 20% to about 30% of the total mixture.

The first halogenated rubber component which includes the cure system, and the non-halogenated component are combined in amounts effective to produce the desired improvement in strength and stability. The relative amounts are as follows:

The relative proportions of the halogenated rubber component used in the practice of the present invention fall within a rather narrow range. The proportion of the halogenated rubber component is from about 10% to about 25% of the total blend. A wetting agent known in the art is further included with the halogenated rubber component. The wetting agent as is known, causes the mixture to blend easier. The preferred proportion of the wetting agent is from about 0.5% to about 1.5% of the total blend;

It is preferred to use from about 1% to about 1.5% of colorant in the total blend. To achieve the desired effect it is preferred to use carbon black in the composition;

As stated, the preferred proportion of petroleum product in the mixture is from about 20% to about 30% of the total mixture;

The amount of a particular filler or pigment which can be used without adversely effecting the fusion properties for example of the resultant product can be readily determined by those skilled in the art. However, such filler can be included in an amount equal to about 48% to about 55% of the blend;

The amount of the tackifier in the mixture is from about 0.5% to 1.5% of the total mixture;

Provided that the proportion of the halogenated rubber component (including the wetting agent and the cure system) in the mixture does not exceed about 30% of the total blend; and

The proportion of the cure system in the mixture does not exceed about 1.5% of the total mixture.

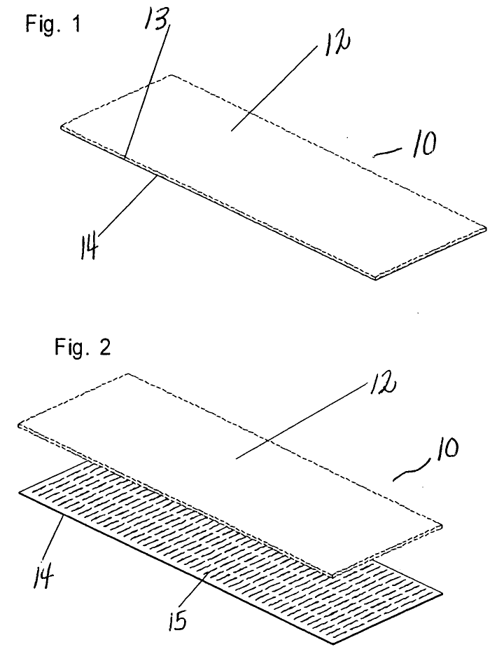

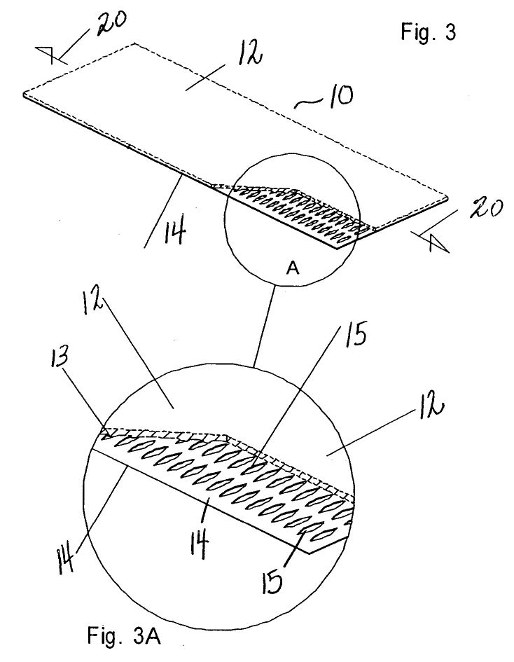

The mesh 14 is a bendable, deformable, and stretchable netting constructed of, but not limited to, cloth, metal, or rubber material. As best shown in FIG. 3A, the mesh 14 is attached to a side 13 of the composition blend 12. As illustrated in FIG. 2, the mesh 14 is shown in its relaxed, non-stretched state. In the relaxed state, the mesh 14 acts as a release liner between the layers of the composition 12. As illustrated in FIGS. 3 and 3A, stretching the tape 10 in direction 20 for wrapping, likewise stretches the mesh 14 to its stretched state. Stretching the mesh 14 defines a plurality of openings 15 within the mesh 14. In application, the stretched mesh 14 allows cross-linking between layers of the composition 12 through the plurality of openings 15 in the stretched mesh 14, thereby allowing the layers to extrude through the openings 15 of the mesh 14 for purposes of bonding.

As stated, while the tape lo is in storage, the mesh layer 12, unstretched, serves as a release liner between layers of the tape 10. In its stretched state, the mesh 14 allows cross-linking between layers of the composition 12. As a result, a removable liner as disclosed in the prior art is unnecessary.

The resulting tape product is strong but can be readily stretched without breaking and is readily handleable over a wide temperature range.

In practicing the present invention, there is formed a blend which is capable of cross-linking, and when stretched, tries to exert continuous force to the application which thereby affects the seal. The blend further demonstrates the presence of a strong cross-link network that upon time and temperature will cross-link the mastic to the elastomer.

The composition blend is prepared by mixing procedures well known in the art, using conventional techniques. This may include for example, initially blending the ingredients in solid form using standard blending equipment at elevated temperatures to improve blending. The resultant blend is then usually cooled, and preformed. Sheets may be prepared such as by passing the blend through a calendar or an extruder equipped with a sheet die. Tapes are produced by cutting the sheet to form tapes having the desired width. Post cross-linking of both layers is affected during the above process.

Further, the mixing order is not critical. For convenience, the components may be blended at one time. Alternatively, the halogenated rubber component (and components of the described cure system) may be blended first, followed by addition of the non-halogenated components and additives.

Layers of the rubber composition 12 are post cured after forming into the final product. The application forms a stretchable tape with “built-in” memory to reform back to its shape before stretching.

Attachment means of the mesh 14 to the formed blend 12 is known in the art.

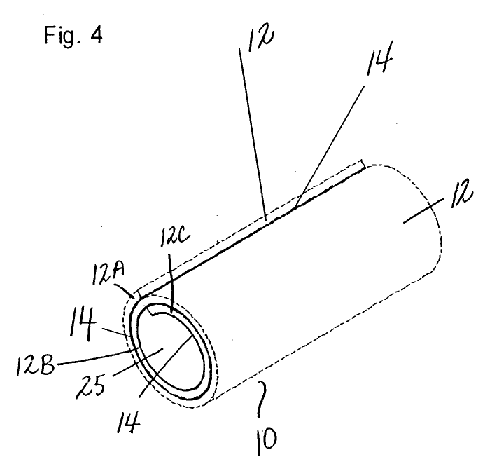

Referring to FIG. 4, the tape 10 is applied to the substrate by subjecting it to a stretching elongation and in the elongated state applying it to the substrate 25, as for example in a wrapping action. Such stretching results in the tape developing the ability to self- bond as the overlapping layers 12A, 12B, 12C (shown in FIG. 4) extrude through the plurality of openings 15 of the mesh 14 such that the overlapping layers adhere strongly to each other. These layers have the appearance of a fused sheet on, or covering the substrate within a few hours of application. We have found that the layers continue to fuse with the increase of time and temperature following application. Until the layers of tacky and non-tacky elastomer have formed cross-linked adhesive bonding between layers. The rebounding properties of the cured non-tacky layer will, during the life of the application, exert an inward pressure that will prevent intrusion of extrusion or water, gases, air, dirt, or other elements.

It has been found that the blended composition demonstrates substantially improved thermal and aging stabilization. Thus, not only is the strength improved, the over characteristics of the resultant product are improved.

The resulting tape of the present invention may be used in a wide variety of applications such as splicing, encapsulation, and connection.

Although the description above contains many specificities, these should not be construed as limiting the scope of the invention but as merely providing illustrations of some of the presently preferred embodiments of the invention. It will be obvious that embodiments described may be varied in many ways. Such variations are not to be regarded as a departure from the spirit and scope of the invention, and all such modifications as would be obvious to one skilled in the art are intended to be included within the scope of the present invention.

Thus the scope of the invention should be determined by the appended claims and their legal equivalents, rather than by the examples given.

I claim:

1. A self-fusing tape for protecting or sealing a substrate, said tape comprising:
an adhesive layer and a mesh,
said adhesive layer comprising a blend of a cross-linkable halogenated rubber component, a non-halogenated modified component, and a cure system, said cure system comprising a combination of phenolic resigns of about 0.5% to about 1.5% of the total mixture blend,
said mesh comprising a plurality of openings such that stretching said mesh allows cross-linking between layers of said adhesive layer through said plurality of openings.

2. The tape as recited in claim 1, wherein said adhesive layer further comprising a petroleum product of about 20% to about 30% of the total blend.

3. The tape as recited in claim 2, wherein the petroleum product is polybutene.

4. The tape as recited in claim 1, wherein the halogenated rubber component is of about 10% to about 25% of the total blend.

5. The tape as recited in claim 4, wherein the halogenated rubber component is further blend with a wetting agent of about 0.5% to about 1.5% of the total blend.

6. The tape as recited in claim 1, further comprising a colorant of about 1% to about 1.5% of the total blend.

7. The tape as recited in claim 6, wherein the colorant is carbon black.

8. The tape as recited in claim 1, further comprising a filler.

9. The tape as recited in claim 8, wherein the filler is about 48% to about 55% of the total blend.

10. The tape as recited in claim 1, wherein the proportion of the halogenated rubber component does not exceed about 30% of the total blend.

11. The tape as recited in claim 1, wherein the proportion of the cure system does not exceed about 2% of the total blend.

12. The tape as recited in claim 1, further comprising a tackifier of about 2% of the total blend.

13. The tape as recited in claim 1, wherein said mesh is constructed of a cloth material.

14. The tape as recited in claim 1, wherein said mesh is constructed of a metal material.

15. The tape as recited in claim 1, wherein said mesh is constructed of a rubber material.

16. The tape as recited in claim 1, wherein the halogenated rubber component is selected from the group consisting of butyl rubber, halogenated butyl rubber, isobutylene homopolymer, ethylene/propylene, diene terpolymers, ethylene/propylene copolymers, polybutadiene, polyisoprene, halogenated isoolefin/paralkylstyrene copolymer, natural rubber and combination mixtures thereof.

17. A process of affixing to a substrate a tape having insufficient tack to self-bond in its relaxed state and comprising a mixture of:
(a) from about 10% to about 25% of the total blend mixture of a cross-linkable halogenated rubber component,
(b) from about 0.5% to about 1.5% of the total blend mixture of a cure system comprising a combination of phenolic resigns,
(c) from about 20% to about 30% of the total blend mixture of a petroleum product,
(d) from about 1% to about 1.5% of the total blend mixture of colorant,
(e) from about 48% to about 55% of the total blend mixture of a filler, said tape further including a mesh comprising a plurality of openings,
wherein said tape is subjected to a stretching elongation immediately prior to contact with the substrate,
wherein the elongated tape is applied to the substrate in a wrapping operating, and
wherein said stretched mesh allows cross-linking between the overlapping layers through said plurality of openings such that said overlapping layers of said tape self-bond to each other.

18. The process of claim 17, wherein the colorant is carbon black.

19. The process as recited in claim 17, wherein the petroleum product is polybutene.

20. The process as recited in claim 17, further comprising a tackifier of about 2% of the total blend mixture.
